(19) United States
(12) Patent Application Publication
(10) Pub. No.: US 2019/0005384 A1
(43) Pub. Date: Jan. 3, 2019

(54) TOPOLOGY AWARE GRAPH NEURAL NETS

(71) Applicant: General Electric Company, Schenectady, NY (US)

(72) Inventors: Bharath Ram Sundar, Bangalore (IN); Radhika Madhavan, Bangalore (IN); Hariharan Ravishankar, Bangalore (IN)

(21) Appl. No.: 15/637,837

(22) Filed: Jun. 29, 2017

(51) Int. Cl. G06N 3/08

(52) U.S. Cl. CPC G06N 3/08; G06N 3/084

(57) ABSTRACT

The present approach relates to the processing of edge information related to graph topology using a neural network. In one aspect, graph topology information along with edge weights are added as a first hidden layer of a neural network. In this manner, better spatial information is transferred to the neural network.

### BACKGROUND

The subject matter disclosed herein relates to data analysis, and in particular to the use of machine learning techniques, such as deep learning, to analyze data, including graph inputs.

Artificial neural networks are a learning tool used in a variety of data analysis tasks, such as data classification, regression, de-noising, dimension reduction and so forth. In addition to optimizing performance of neural networks on these tasks, there is also a need to interpret the outputs of the neural network and learnt parameters for a greater understanding of the specific problem and domain.

In the context of graph learning applications, use of artificial neural networks may be unsuitable for achieving an understanding of which nodes of the graph data being analyzed contribute more to the analysis results. In particular, processing by the neural network is typically done in such a manner that the underlying graph topology is hidden from the learning unit. This may hinder interpretation of the data analysis results, as it may be difficult to interpret which nodes of the graphs contributes more to the analysis results, e.g., the regression or classification results.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible embodiments. Indeed, the invention may encompass a variety of forms that may be similar to or different from the embodiments set forth below.

In one aspect of the present approach, a neural network is provided. In accordance with this aspect, the neural network comprises an input layer, a plurality of hidden layers, and an output layer downstream from the plurality of hidden layers. The output layer is configured to provide an output of the neural network. The plurality of hidden layers include a first hidden layer configured as a graph-node layer. The trained graph-node layer encodes edge incidence information related to input graph data and constrains data relationships analyzed by downstream hidden layers.

In a further aspect of the present approach, a method for processing graph inputs is provided. In accordance with this method, graph data is received as an input at an input layer of a neural network. The graph data is constrained based on edge relationships at a graph-node layer prior to the constrained graph data being processed by one or more hidden layers of the neural network. The constrained graph data is processed using the one or more hidden layers. An output of the one or more hidden layers is generated at an output layer of the neural network.

In an additional aspect of the present approach, one or more non-transitory computer-readable media encoding processor-executable routines are provided. In accordance with this aspect, the routines, when executed by a processor, cause acts to be performed comprising: receiving graph data as an input at an input layer of a neural network; constraining the graph data based on edge relationships at a graph-node layer prior to the constrained graph data being processed by one or more hidden layers of the neural network; processing the constrained graph data using the one or more hidden layers; and generating an output of the one or more hidden layers at an output layer of the neural network.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 depicts an example of an artificial neural network for training a deep learning model, in accordance with aspects of the present disclosure;

FIG. 2 depicts a process flow of the use of a topology aware neural network in inputting graph data, in accordance with aspects of the present disclosure;

FIG. 3 depicts a conventional approach for processing an adjacency matrix input using a neural network;

FIG. 4 depicts a neural network having a graph-node layer as a first hidden layer for processing an adjacency matrix input in accordance with the present approach;

FIG. 5 illustrates edge incidence relation encoded in accordance with the present approach;

FIG. 6 depicts a process overview flowchart of the processing a graph inputs using a neural network in accordance with the present approach;

FIG. 7 is a block diagram of a computing device capable of implementing the present approach, in accordance with aspects of the present disclosure

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure

While aspects of the following discussion are provided in the context of analysis of medical data, it should be appreciated that the present techniques are not limited to such medical contexts. Indeed, the provision of examples and explanations in such a medical context is only to facilitate explanation by providing instances of real-world implementations and applications. However, the present approaches may also be utilized in other suitable data analysis context. In general, the present approaches may be useful in any data analysis context where graph inputs are analyzed. As used herein, such graphs or graph inputs may be understood as encompassing graphs (V,E), where each graph is defined by its vertices (nodes, V) and edges (E) that connect the vertices. The topology of such graphs may be obtained or realized by “gluing” together edges coincident on the same vertex.

The present approach addresses certain challenges associated with data analysis of unstructured data, including graph inputs. Such unstructured data may be generated by spatially distributed but connected sensors and/or interacting multi-agent systems, and thus differing sensor measurements may be associated with different nodes, with the nodes themselves potentially having a spatial relationship to one another. By way of a practical example, brain imaging may utilize spatially distributed but connected sensors to measure electrical activity in the brain, generating graph data as an output.

When analyzing such graph data using deep learning techniques, such data (as discussed in greater detail below) is “flattened”, which may lead to the loss of certain informational aspects of the data. This may reduce the interpretability of the significance of different nodes or node locations in the analyzed data. Such a lack of interpretability may have real world consequences. For example in a healthcare context, an expert clinician or radiologist may want to know which features (i.e., nodes) contributed to a specific disease condition along with a prediction. Similarly, in a multi-sensor or multi-agent systems, it might be useful to identify contributions from individual sensors/agents towards the common goal.

In addition, other approaches may compute node-based metrics from the graphs and input these metrics to a neural network, allowing weights from the input layer to be used as a measure of node influences. However, node-based metrics over simplify the graph representation and complete reconstruction of the original data is not possible. Hence, such approaches may lead to underperformance and inaccurate results.

The present approach addresses these issues by encoding the explicit graph topology in the artificial neural network analysis, and thereby improves interpretability or relevance of individual or groups of graph nodes, facilitating diagnostic and/or predictive aspects of the analysis. In particular, in one approach a node based layer is inserted for encoding graph topology while inputting data from graphs (as adjacency matrices) to an artificial neural network. By introducing an extra layer that encodes topology, the “graph” structure is retained & transmitted through the neural networks, which aids interpretability of the results. Once such a network is trained, the weights of the node based layer indicate the relative influence of individual nodes in performing the learning task.

With the preceding introductory comments in mind, aspects of the present approaches described herein utilize neural networks in the analysis of unstructured data, including graph data. Neural networks as discussed herein may encompass deep neural networks, fully connected networks, convolutional neural networks (CNNs), perceptrons, auto encoders, recurrent networks, wavelet filter banks, or other neural network architectures. These techniques are referred to herein as deep learning techniques, though this terminology may also be used specifically in reference to the use of deep neural networks, which is a neural network having a plurality of layers.

As discussed herein, deep learning techniques (which may also be known as deep machine learning, hierarchical learning, or deep structured learning) are a branch of machine learning techniques that employ mathematical representations of data and artificial neural network for learning. By way of example, deep learning approaches may be characterized by their use of one or more algorithms to extract or model high level abstractions of a type of data of interest. This may be accomplished using one or more processing layers, with each layer typically corresponding to a different level of data abstraction and, therefore potentially employing or utilizing different aspects of the initial data or outputs of a preceding layer (i.e., a hierarchy or cascade of layers) as the target of the processes or algorithms of a given layer. In a data analysis context, this may be characterized as different layers corresponding to the different feature levels or levels of abstraction in the data.

In general, the processing from one level or abstraction to the next can be considered as one ‘stage’ of the analysis process. Each stage of the analysis can be performed by separate neural networks or by different parts of one larger neural network. For example, as discussed herein, a single deep learning network may cover all stages in an analytic process (e.g., from an initial input to an output data set). Alternatively, separate distinct deep learning network(s) may each cover only one stage (or a subset of stages) of the overall analysis process.

As part of the initial training of deep learning processes to solve a particular problem, training data sets may be employed that have known initial values and known or desired values for a final output of the deep learning process. The training of a single stage may have known input values corresponding to one representation space and known output values corresponding to a next-level representation space. In this manner, the deep learning algorithms may process (either in a supervised or guided manner or in an unsupervised or unguided manner) the known or training data sets until the mathematical relationships between the initial data and desired output(s) are discerned and/or the mathematical relationships between the inputs and outputs of each layer are discerned and characterized. Similarly, separate validation data sets may be employed in which both the initial and desired target values are known, but only the initial values are supplied to the trained deep learning algorithms, with the outputs then being compared to the outputs of the deep learning algorithm to validate the prior training and/or to prevent over-training.

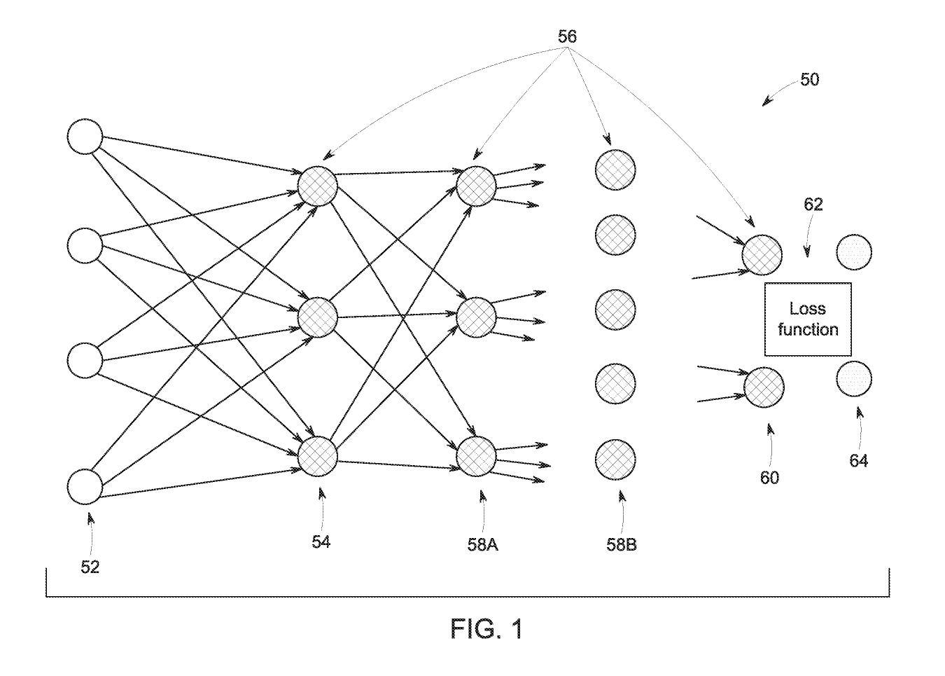

With the preceding in mind, FIG. 1 schematically depicts an example of an artificial neural network 50 that may be trained as a deep learning model as discussed herein. In this example, the network 50 is multi-layered, with a training input 52 and multiple layers including an input layer 54, hidden layers 58A, 58B, and so forth, and an output layer 60 and the training target 64 present in the network 50. Each layer, in this example, is composed of a plurality of “neurons” or nodes 56. The number of neurons 56 may be constant between layers or, as depicted, may vary from layer to layer. Neurons 56 at each layer generate respective outputs that serve as inputs to the neurons 56 of the next hierarchical layer. In practice, a weighted sum of the inputs with an added bias is computed to “excite” or “activate” each respective neuron of the layers according to an activation function, such as rectified linear unit (ReLU), sigmoid function, hyperbolic tangent function, or otherwise specified or programmed. The outputs of the final layer constitute the network output 60 which, in conjunction with a target value or construct 64, are used to compute some loss or error function 62, which will be backpropagated to guide the network training.

The loss or error function 62 measures the difference between the network output 60 and the training target 64. In certain implementations, the loss function may be a mean squared error (MSE). Alternatively, the loss function 62 could be defined by other metrics associated with the particular task in question, such as a softmax function.

With the preceding in mind, the neural network 50 may be trained for use in the analysis of unstructured data, including graph data, as discussed herein.

The task of the trained neural network might be to regress or classify graph inputs. However, as noted above, depending on the actual application, there may be significance to understanding which nodes of the graphs contributed more to the regression and/or classification analysis. In particular, in conventional approaches, the graph is fed to a neural network as a flattened vector of its adjacency matrix. This conventional approach obscures or hides the underlying graph topology from the learning unit. As discussed herein, the present approach instead preserves the graph topology (i.e., spatial information derived from the adjacency matrix) to enable or otherwise facilitate node based inferences. In one example, this is accomplished by adding a layer for nodes to the neural network 50 next to the input layer 54, as discussed in greater detail below. The nodal influences are computed from weights of the added node layer in the trained neural network 50.

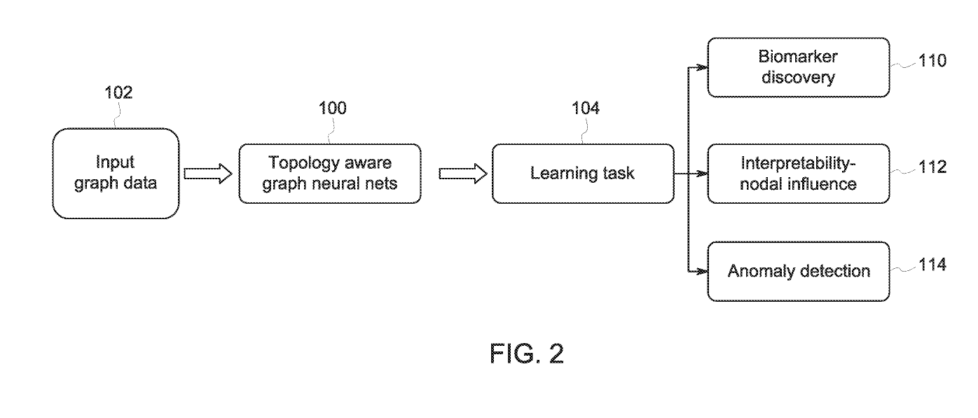

As a consequence, and turning to FIG. 2, the trained neural network 50 configured in this manner constitutes a topology aware graph neural net 100 configured to receive graph data as an input (step 102) to perform a learning task (step 104), including, but not limited to, biomarker discovery 110, nodal influence interpretation 112, and/or anomaly detection 114 based on the input graph data 102.

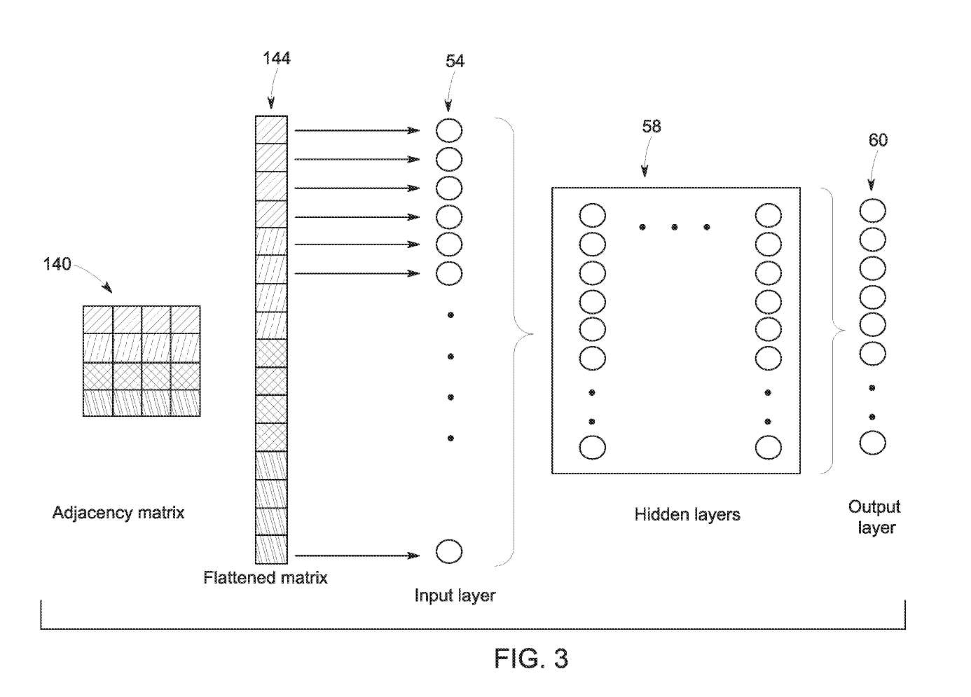

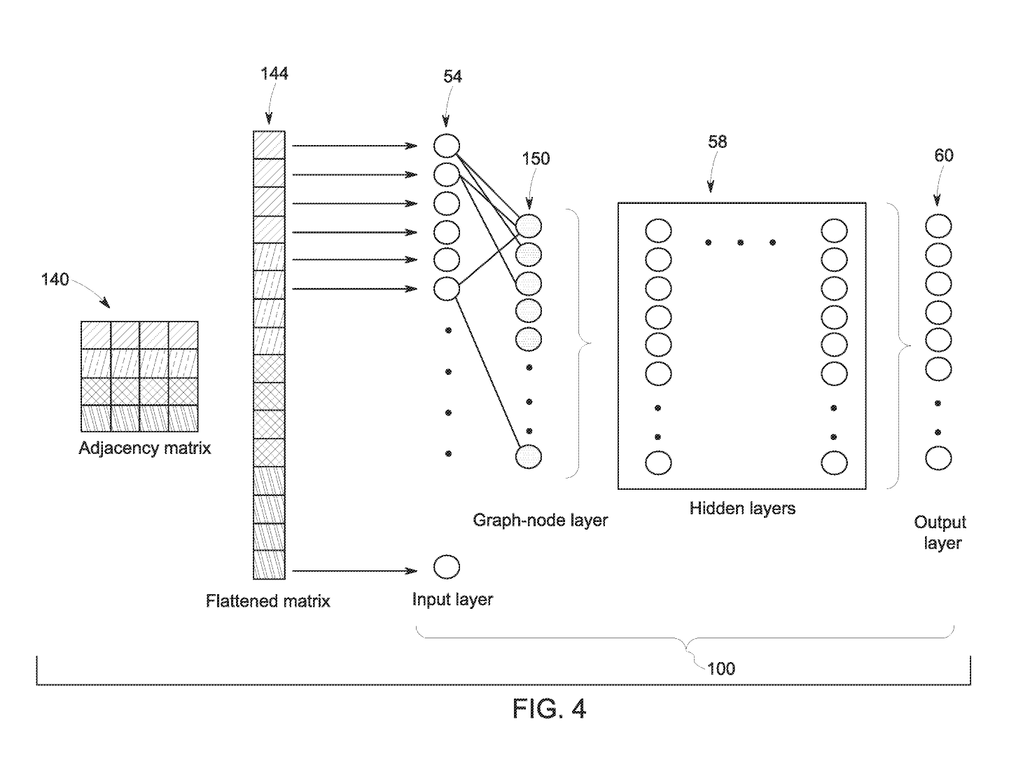

With the above in mind, FIGS. 3 and 4 depict visual examples of the conventional approach for analyzing graph inputs (FIG. 3) in comparison to the present approach discussed herein (FIG. 4). Turning to these figures, consider

With the preceding in mind, and turning to FIG. 3 consider a set of ‘m’ graphs G={g1, g2 . . . gm} with labels L={l1, l2 . . . lm} corresponding to each. In a conventional approach this graph data may be input to an artificial neural network using an adjacency matrix approach. A schematic of a typical neural-network in accordance with the conventional approach is shown in FIG. 3. If the graphs are on ‘n’ nodes, then a n×n adjacency matrix 140 is used as input to the neural network 50. The input layer 54 has n×n neural-network-nodes (neurons) obtained by flattening the n×n adjacency matrix 140 to generate a flattened matrix 144. The number of neurons in the output layer 60 depends on the dimension of the label vector, which depends on the task. For example, a two-class classification has only one dimensional label vector with binary values. Any number of hidden layers 58 with varying number of neurons may be added to form the network 50. As will be appreciated, spatial and adjacency information present in the adjacency matrix 140 is not present in the flattened matrix 144, i.e., is lost in the flattening process.

Conversely, turning to FIG. 4, in accordance with the present approach, a neural net architecture is employed with an additional graph-node based hidden layer (i.e., graph-node layer 150) at after the input layer 54. The number of neurons in this graph-node layer 150 is the same as the number of nodes in the graph. Each neuron corresponds to a graph node and hence is connected to only specific inputs of the input layer 54, which correspond to edges incident on that node in the graph.

By way of example, an input neuron for the edge (i,j) is connected to neurons corresponding to nodes i and j. Thus, ith node in the new layer is connected to all inputs corresponding to ith row and ith column of the adjacency matrix 140. Since the ith row and ith column of the adjacency matrix 140 are the edges that connect to the ith graph-node, the graph topology information is thus fed to the topology aware neural network 100. Each input neuron has only two connections and this leads to reduce the number of parameters compared to using a dense layer (i.e., where each input is connected to each output).

This may be expressed as:

$${W}_{ij}^{k} = \{ \begin{matrix}{W}_{ij}^{k} , & edge i incident on j \\ 0 , & otherwise\end{matrix} \qquad ( 1 )$$

where W^{k} is an input corresponding to the first hidden layer (i.e., the graph-node layer 150) weight matrix, i is the neuron index of the input layer 54 (i.e., input edge index), and j is the neuron index of the first hidden layer (i.e., the graph-node layer 150), hence the graph node index.

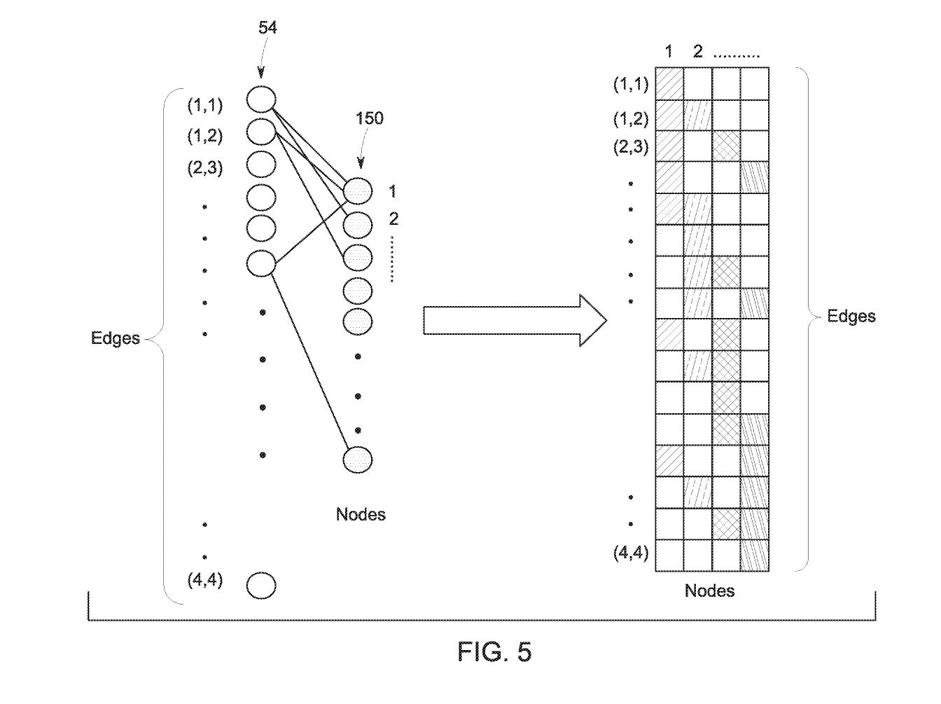

This equation is illustrated diagrammatically in FIG. 5, where, on the left-hand side, the graph-node layer 150 is depicted. Each neuron of the graph-node layer 150 is connected to those input layer 54 neurons having a corresponding edge relationship. On the right-hand side of FIG. 5, a graphical representation is shown representing the node-based hidden layer connections for the example graph on four nodes (i.e., nodes 1, 2, 3, and 4) in rows and edges [(1,1,), (1,2), (1,3), . . . , (1,4)) in columns as a grid. Shading in the right-hand depiction is indicative of non-zero weights (i.e., an edge relationship). Thus, row (i, j) has non-zero weight connections to column i and column j. Thus, row (1, 2) has non-zero-weights in columns 1 and 2. In this manner, edge and/or adjacency (including diagonal edge or adjacency relationships) of nodes may be used to effectively weight flattened graph data immediately after the input layer 54 so as to restore edge information otherwise lost in the flattening process, with non-adjacent nodes being assigned a zero-weight. In particular, as shown in FIGS. 4 and 5, the graph-node layer 150 acts as a constraint on the input layer 54 such that only node inputs having an adjacent or edge relationship are processed in the subsequent hidden layer 58. That is, the graph-node layer 150 captures topology information that would be otherwise lost and thereby limits connections between nodes. Once such a topology aware graph neural net 100 is built and trained for a specific task, the importance of each graph node neuron (i.e., the first hidden layer neurons) is computed from the weights of the network neuron.

In a further implementation, it may be noted that, in many cases of graph learning, the edge list is not exhaustive. Thus, some of the edges may not be a part of any of the input graph instances. In such an instance, it is possible to get a super set of edges from the inputs and to use this super set as an input feature vector for the neural network. Thus, the topology of the graph is fixed and the inputs instances vary only in the edge weights.

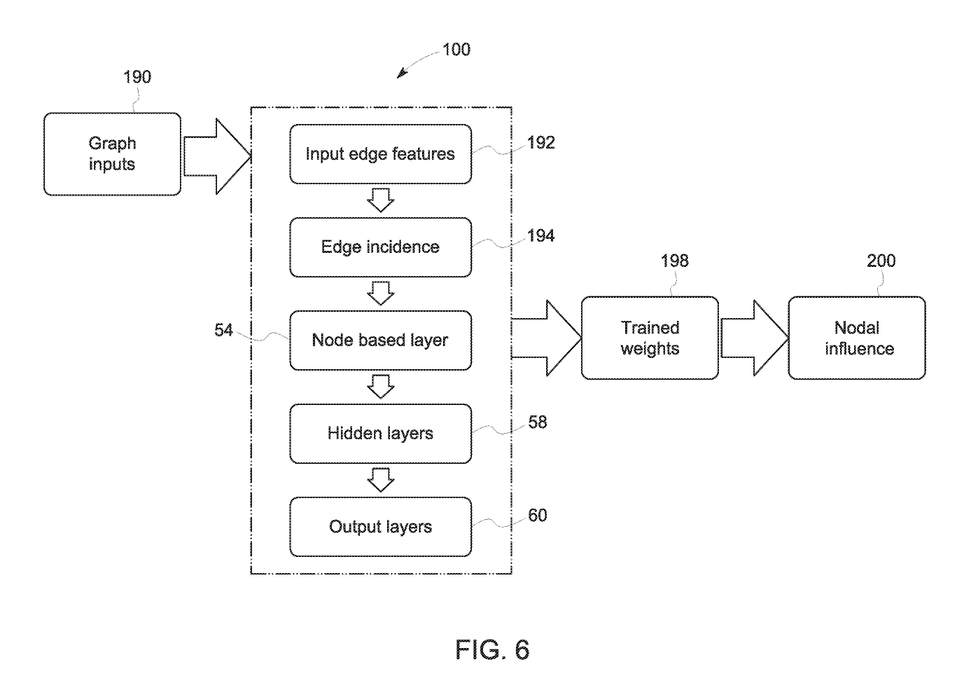

Turning to FIG. 6, an overview of the corresponding process is shown with respect to the above described approach. As shown graph inputs 190 are initially provided to a topology aware graph neural net 100. Based on the graph inputs edge features 192 are derived. Based on these features 192, edge incidence 194 is also determined. Edge incidence 194 is processed via a node-based layer 54 that constrains data analysis of the graph inputs in learning module, i.e., hidden layers 58. The outputs of the hidden layers 58 constitute the output layers 60 of the neural net 100.

The trained graph-node layer constitutes a set of zero and non-zero weights, with non-zero weights corresponding to edge incidence and zero weights corresponding to a lack of edge incidence. The non-zero weights may be across a range of values from greater than zero to less than or equal to 1, with the magnitude of the weight conveying useful information. Correspondingly, the trained weights 198 of the node-based layer 54 may be analyzed to derive indications of relative or absolute nodal influence 200 in the analysis performed by the topology aware graph neural network 100. Such measures of nodal influence may be used to interpret the significance of different nodes or node locations in the analyzed data.

The present approach was applied in a functional magnetic resonance imaging (fMRI) study. In particular, the present framework was applied to resting state fMRI based functional connectivity graph data (total: 100 scans from 10 volunteers) for a reconstruction task with an autoencoder neural network. Nodal influence measures were extracted from the same. In this context, each sensor generates time series data particular to that node which corresponds to a spatial location in the brain. Graph input or graph data, particular to a node (spatial location in the brain) corresponds to the correlation coefficient between time courses of that location to other locations in the brain. Processing of the time series data in accordance with the present approach yields functional brain network data, including analysis of the significance of respective nodes corresponding to respective measurement sites, and thereby to respective brain structures, which may be useful in data interpretation.

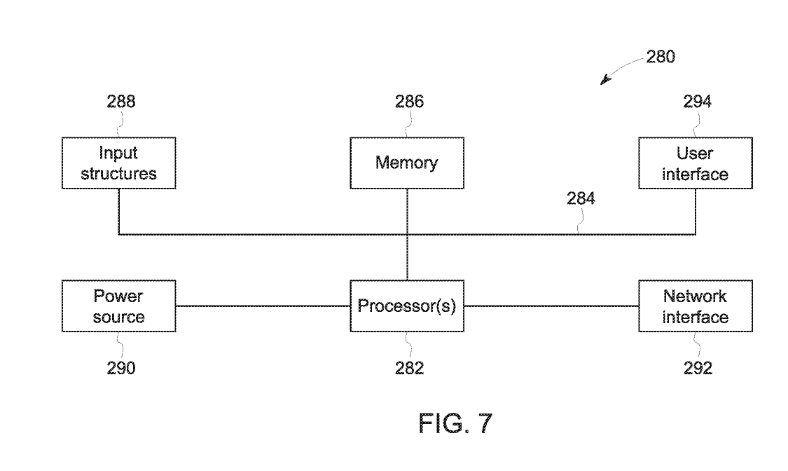

As will be appreciated some or all of the preceding aspects may be performed or otherwise implemented using a processor-based system such as shown in FIG. 7. Such a system may include some or all of the computer components depicted in FIG. 7. FIG. 7 generally illustrates a block diagram of example components of a computing device 280 and their potential interconnections or communication paths, such as along one or more busses. As used herein, a computing device 280 may be implemented as one or more computing systems including laptop, notebook, desktop, tablet, or workstation computers, as well as server type devices or portable, communication type devices, and/or other suitable computing devices.

As illustrated, the computing device 280 may include various hardware components, such as one or more processors 282, one or more busses 284, memory 286, input structures 288, a power source 290, a network interface 292, a user interface 294, and/or other computer components useful in performing the functions described herein.

The one or more processors 282 are, in certain implementations, microprocessors configured to execute instructions stored in the memory 286 or other accessible locations. Alternatively, the one or more processors 282 may be implemtned as application-specific integrated circuits (ASICs), field-programmable gate arrays (FPGAs), and/or other devices designed to perform functions discussed herein in a dedicated manner. As will be appreciated, multiple processors 282 or processing components may be used to perform functions discussed herein in a distributed or parallel manner.

The memory 286 may encompass any tangible, non-transitory medium for storing data or executable routines, including volatile memory, non-volatile memory, or any combination thereof. Although shown for convenience as a single block in FIG. 8, the memory 286 may actually encompass various discrete media in the same or different physical locations. The one or more processors 282 may access data in the memory 286 via one or more busses 284.

The input structures 288 are used to allow a user to input data and/or commands to the device 280 and may include mice, touchpads, touchscreens, keyboards, and so forth. The power source 290 can be any suitable source for providing power to the various components of the computing device 280, including line and battery power. In the depicted example, the device 100 includes a network interface 292. Such a network interface 292 may allow communication with other devices on a network using one or more communication protocols. In the depicted example, the device 100 includes a user interface 114, such as a display configured to display images or date provided by the one or more processors 282.

As will be appreciated, in a real-world context a processor-based systems, such as the computing device 280 of FIG. 1, may be employed to implement some or all of the present approach, such as to implement a topology aware neural network.

Technical effects of the invention include adding information about graph topology along with edge weights as a first hidden layer of a neural network. In this manner, better spatial information is transferred to the neural network, which will serve to aid in more accurate learning. For example, in neuroimaging data, potential biomarkers can be derived from graph analysis using the nodal layer.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A neural network, comprising:
an input layer;
a plurality of hidden layers, comprising:
a first hidden layer configured as a graph-node layer, wherein the graph-node layer, when trained, encodes edge incidence information related to input graph data and constrains data relationships analyzed by downstream hidden layers; and
an output layer downstream from the plurality of hidden layers, wherein the output layer is configured to provide an output of the neural network.

2. The neural network of claim 1, wherein the graph-node layer comprises a number of neurons equivalent to a number of nodes in the input graph data.

3. The neural network of claim 1, wherein each neuron of the graph-node layer corresponds to a respective node of the input graph data and is connected to a subset of neurons of the input layer

4. The neural network of claim 3, wherein the subset of neurons of the input layer to which a respective neuron of the graph-node layer is connected corresponds to the edge incidence of the respective node of the input graph data represented by that respective neuron of the graph-node layer.

5. The neural network of claim 1, wherein the neurons of the graph-node layer, when trained, comprise non-zero weights for nodes having an adjacency relationships and zero-weights for nodes having non-adjacency.

6. The neural network of claim 1, wherein the graph-node layer constrains the input layer such that only nodes of the input graph data having an adjacent or edge relationship are processed in the subsequent hidden layers.

7. The neural network of claim 1, wherein the input graph data comprises sensor data generated by one or more of spatially-distributed, interconnected sensors or interacting multi-agent systems.

8. The neural network of claim 1, wherein the input graph data comprises time series data generated by a plurality of sensors positioned at different points on a patient's body.

9. A method of processing graph inputs, comprising:
receiving graph data as an input at an input layer of a neural network;
constraining the graph data based on edge relationships at a graph-node layer prior to the constrained graph data being processed by one or more hidden layers of the neural network;
processing the constrained graph data using the one or more hidden layers; and
generating an output of the one or more hidden layers at an output layer of the neural network.

10. The method of claim 9, wherein the graph data comprises a flattened adjacency matrix.

11. The method of claim 9, wherein the graph-node layer, when trained, comprises non-zero weight values corresponding to edge relationships and zero weight values corresponding to no-edge relationship.

12. The method of claim 9, further comprising:
analyzing the weight values of the graph-node layer of a trained neural network to assess the respective influence of one or more nodes of the graph data.

13. The method of claim 9, wherein the graph-node layer conveys the topology of the graph data through the subsequent hidden layers.

14. The method of claim 9, wherein the graph-node layer constrains the graph data such that only nodes of the graph data having an adjacent or edge relationship are processed in the subsequent hidden layers.

15. One or more non-transitory computer-readable media encoding processor-executable routines, wherein the routines, when executed by a processor, cause acts to be performed comprising:
receiving graph data as an input at an input layer of a neural network;
constraining the graph data based on edge relationships at a graph-node layer prior to the constrained graph data being processed by one or more hidden layers of the neural network;
processing the constrained graph data using the one or more hidden layers; and
generating an output of the one or more hidden layers at an output layer of the neural network.

16. The one or more non-transitory computer-readable media of claim 15, wherein the graph data comprises a flattened adjacency matrix.

17. The one or more non-transitory computer-readable media of claim 15, wherein the graph-node layer, when trained, comprises non-zero weight values corresponding to edge relationships and zero weight values corresponding to no-edge relationship.

18. The one or more non-transitory computer-readable media of claim 15, wherein the routines, when executed by the processor, cause further acts to be performed comprising:
analyzing the weight values of the graph-node layer of a trained neural network to assess the respective influence of one or more nodes of the graph data.

19. The one or more non-transitory computer-readable media of claim 15, wherein the graph-node layer conveys the topology of the graph data through the subsequent hidden layers.

20. The one or more non-transitory computer-readable media of claim 15, wherein the graph-node layer constrains the graph data such that only nodes of the graph data having an adjacent or edge relationship are processed in the subsequent hidden layers.
